(19) United States
(12) Patent Application Publication
(10) Pub. No.: US 2012/0293243 A1
(43) Pub. Date: Nov. 22, 2012

(54) SEMICONDUCTOR DEVICE INCLUDING BOOSTING CIRCUIT

(76) Inventor: Yoshinao Suzuki, Yokohama-shi (JP)

(21) Appl. No.: 13/427,009

(22) Filed: Mar. 22, 2012

(30) Foreign Application Priority Data
May 16, 2011 (JP) 2011-109403

(51) Int. Cl. G05F 3/02

(52) U.S. Cl. 327/536

(57) ABSTRACT

According to one embodiment, a semiconductor device includes the following configuration. A control circuit controls an output voltage to a predetermined voltage, based on a monitor voltage configured to monitor the output voltage. A switch circuit sets the output voltage to first and second voltages in first and second operation states, respectively. The second voltage is higher than the first voltage. A clock driver generates a clock signal that includes a voltage level of the output voltage as an amplitude thereof. A charge pump is formed by connecting unit circuits in series and at multiple stages. Each of the unit circuits includes a capacitor and a diode. The charge pump boosts an input voltage by the clock signal that is inputted to the capacitor.

### CROSS-REFERENCE TO RELATED APPLICATIONS

This application is based upon and claims the benefit of priority from prior Japanese Patent Application No. 2011-109403, filed May 16, 2011, the entire contents of which are incorporated herein by reference.

### FIELD

Embodiments described herein relate generally to a semiconductor device including a boosting circuit.

### BACKGROUND

For example, in non-volatile semiconductor storage devices, a voltage which is higher than a power supply voltage VCC is required for each operation such as writing and erasing of data in a memory cell, and reading data from a memory cell. Therefore, non-volatile semiconductor storage devices need boosting circuits which boost the power supply voltage VCC and generate high voltage.

For example, in NAND flash memories, a voltage of about 20 V for a selected cell and a voltage of about 10 V (VPASS) for a non-selected cell are required when data is written in a memory cell. When data of a memory cell is erased, a voltage of about 20 V is necessary for the well. In addition, a voltage of about 5 V is necessary for reading a memory cell, and all the voltages are generated by the boosting circuit.

A method which is generally called a charge pump circuit is widely used for boosting circuits. An example of the charge pump circuit has a structure in which basic unit circuits, each of which includes a capacitor and a diode-connected MOS transistor, are connected in series and at multiple stages, a pulse-like bias voltage (clock) is applied to one electrode of the capacitor, and thereby electric charges are transferred to the next stage for each clock, and a potential of a capacitive load of an output is increased. Other charge pump circuits of various structures have been proposed.

However, when high boosted voltage is required in charge-pump boosting circuits, the number of stages of the basic unit circuits, each of which is formed of a capacitor and a diode, increases. In addition, there is the problem of increase in circuit area and decrease in boost efficiency (increase in power consumption), due to influence of the substrate bias effect caused by increase in source potential of each diode-connected MOS transistor.

Besides, in NAND flash memories, a boosting capacity which is larger than that provided by the product specification is required to estimate the threshold distribution of memory cells, a VPASS window, and a cell current. Therefore, the capacity of the boosting circuit and the circuit area are excessive for the product specification, which results in increase in chip area and cost. The term “product specification” indicates a requirement which the end product should meet, and the boosting circuit is required to boost the output to a desired voltage within a prescribed time.

### BRIEF DESCRIPTION OF THE DRAWINGS

FIG. 1 is a flow chart illustrating a flow from design to manufacturing of a NAND flash memory according to an embodiment.

FIG. 2 is a circuit diagram illustrating a structure of a clock signal generating circuit according to the embodiment.

FIG. 3 is a circuit diagram illustrating a structure of a voltage generating circuit according to the embodiment.

FIG. 4 is a circuit diagram illustrating a structure of a charge pump in FIG. 3.

FIG. 5 is a diagram illustrating relation between the number of stages of the charge pump and a boosted voltage in the boosting circuit of the embodiment.

### DETAILED DESCRIPTION

A semiconductor device of an embodiment will be explained hereinafter with reference to drawings. In the following explanation, an NAND flash memory is explained as an example of the semiconductor device. In the following explanation, constituent elements which have the same function and structure are denoted by the same reference numeral, and overlapping explanation will be made only when necessary.

In general, according to one embodiment, a semiconductor device includes a control circuit, a switch circuit, a clock driver and a charge pump. The control circuit controls an output voltage to a predetermined voltage, based on a monitor voltage configured to monitor the output voltage. The switch circuit sets the output voltage to a first voltage in a first operation state, and sets the output voltage to a second voltage in a second operation state. The second voltage is higher than the first voltage. The clock driver generates a clock signal that includes a voltage level of the output voltage as an amplitude thereof. The charge pump is formed by connecting unit circuits in series and at multiple stages. Each of the unit circuits includes a capacitor and a diode. The charge pump boosts an input voltage by the clock signal that is inputted to the capacitor.

[1] Flow from Design to Manufacturing

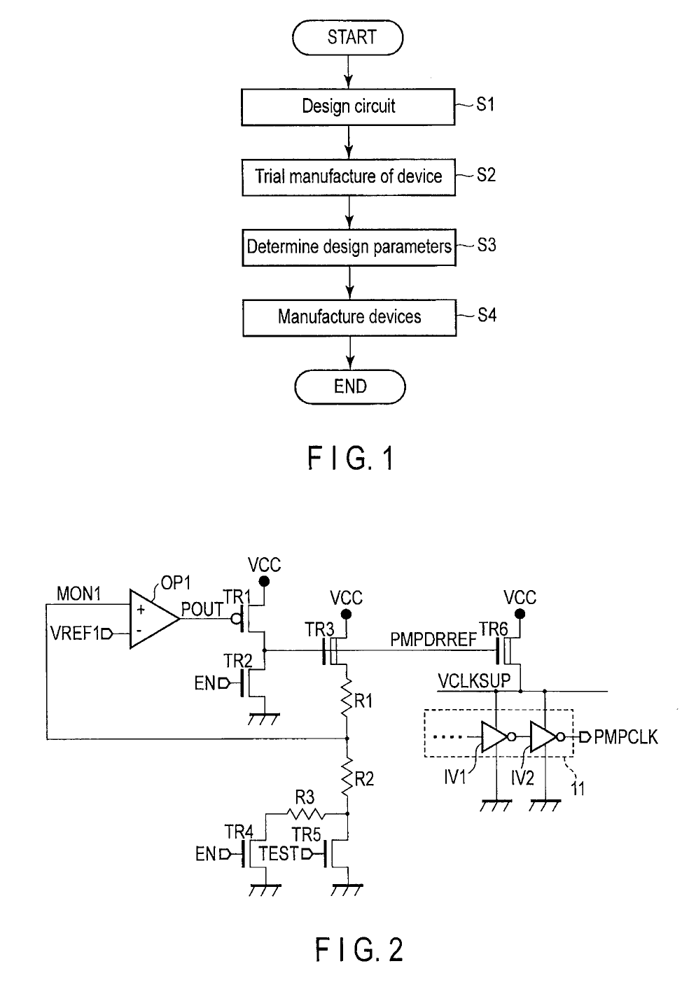

FIG. 1 is a flow chart illustrating flow from design to manufacturing of a NAND flash memory according to an embodiment.

In NAND flash memories, work from design to manufacturing is performed by the following flow.

First, circuit design of a memory cell array and a peripheral circuit which form the NAND flash memory is performed (Step S1). Next, trial manufacture of the NAND flash memory (device) is performed (Step S2). A memory cell array and a peripheral circuit are formed on a semiconductor substrate. The memory cell array includes a plurality of nonvolatile memory cells which store data. The peripheral circuit includes a circuit configured to perform writing, reading, and erasing for the memory cells. For example, the peripheral circuit includes a boosting circuit (internal power supply circuit) which generates a voltage necessary for these operations. The boosting circuit generates a boosted voltage by boosting a power supply voltage supplied from the outside.

Next, various evaluations are performed for the trial NAND flash memory by using a voltage which is boosted by the boosting circuit, and design parameters in the NAND flash memory are determined (Step S3). Thereafter, manufacturing of NAND flash memories with the determined design parameters is performed (Step S4).

When the NAND flash memory is evaluated at Step S3 in the above flow from design to manufacturing, for example, the following operation is performed.

The power supply voltage is boosted by the boosting circuit provided in the peripheral circuit of the NAND flash memory, and thereby a boosted voltage, for example, a voltage VPASS is generated. Then, a test of writing operation is performed by using the voltage VPASS. Although the structure of generating a voltage VPASS as boosted voltage is explained hereinafter, the embodiment is not limited to this structure, but may be applicable in the same manner to another voltage which is boosted in the peripheral circuit, such as a writing voltage VPGM and a reading voltage VREAD, by adding some proper changes.

[2] Structure of Boosting Circuit

The boosting circuit in the peripheral circuit includes a clock signal generating circuit, and a voltage generating circuit which includes a charge pump. The clock signal generating circuit generates a clock signal for driving the charge pump. The voltage generating circuit boosts the power supply voltage by using the power supply voltage and the clock signal for driving the charge pump. The following is explanation of the clock signal generating circuit and the voltage generating circuit.

FIG. 2 is a circuit diagram illustrating a structure of the clock signal generating circuit.

As illustrated in FIG. 2, the clock signal generating circuit includes a differential amplifier OP1, a p-channel MOS transistor TR1, an n-channel MOS transistor TR2, a depression n-channel MOS transistor TR3, n-channel MOS transistors TR4 and TR5, a depression n-channel MOS transistor TR6, resistors R1, R2, and R3, and a clock driver 11. The clock driver 11 includes a plurality of inverters which include inverters IV1 and IV2.

An output end of the differential amplifier OP1 is connected to a gate of the transistor TR1. One end of a current path of the transistor TR1 is supplied with a power supply voltage VCC, and the other end of the current path is connected to a reference potential (for example, a ground potential) through a current path of the transistor TR2. An enable signal EN is inputted to a gate of the transistor TR2. The other end of the current path of the transistor TR1 is also connected to gates of the transistors TR3 and TR6.

One end of a current path of the transistor TR3 is supplied with the power supply voltage VCC, and the other end of the current path is connected to the ground potential through the resistors R1 and R2 and a current path of the transistor TR5. A node between the resistor R1 and the resistor R2 is connected to a positive (+) input end of the differential amplifier OP1. A reference voltage VREF1 is inputted to a negative (−) input end of the differential amplifier OP1. A node between the current path of the transistor TR5 and the resistor R2 is connected to the ground potential through the resistor R3 and a current path of the transistor TR4. An enable signal EN is inputted to a gate of the transistor TR4.

One end of a current path of the transistor TR6 is supplied with the power supply voltage VCC, and the other end of the current path is connected to a first power supply end of each of the inverters IV1 and IV2 in the clock driver 11. Second power supply ends of the inverters IV1 and IV2 in the clock driver 11 are connected to the ground potential respectively.

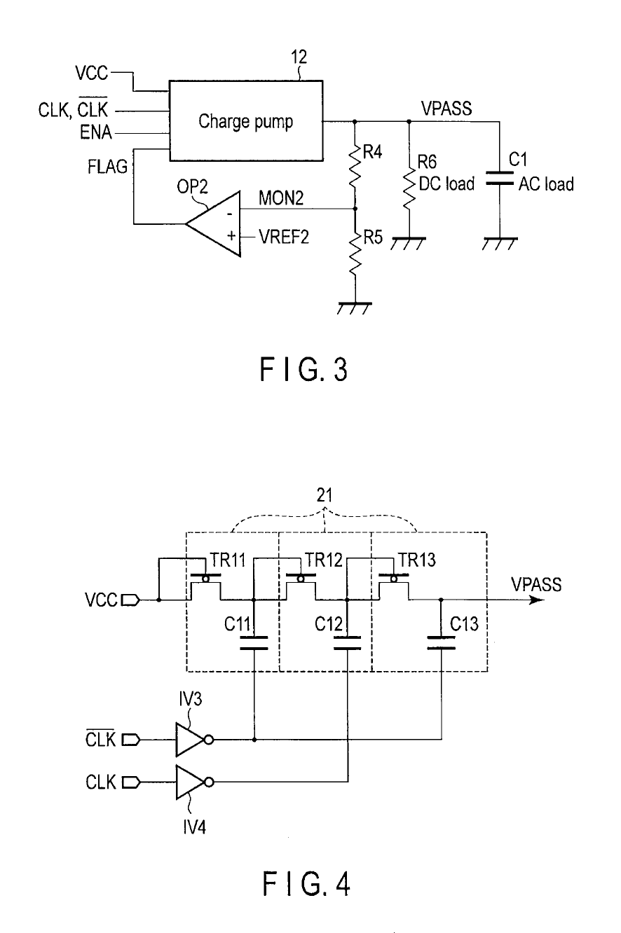

FIG. 3 is a circuit diagram illustrating a structure of the voltage generating circuit.

As illustrated in FIG. 3, the voltage generating circuit includes a charge pump 12, a differential amplifier OP2, resistors R4, R5, and R6, and a capacitor C1. The resistor R6 and the capacitor C1 indicate a DC load and an AC load, respectively.

A power supply voltage VCC, clock signals CLK and /CLK, and an enable signal EN are inputted to the charge pump 12. The clock signal /CLK is an inverted signal of the clock signal CLK. An output end of the charge pump 12 is connected to the ground potential through the resistors R4 and R5.

A node between the resistor R4 and the resistor R5 is connected to a negative (−) input end of the differential amplifier OP2. A reference voltage VREF2 is inputted to a positive (+) input end of the differential amplifier OP2. An output end of the differential amplifier OP2 is connected to the charge pump 12. An output end of the charge pump 12 outputs a voltage VPASS.

FIG. 4 is a circuit diagram illustrating a structure of the charge pump 12 in FIG. 3.

As illustrated in FIG. 4, the charge pump 12 includes intrinsic (I-type) n-channel MOS transistors TR11, TR12, and TR13, capacitors C11, C12, and C13, and inverters IV3 and IV4. The transistors TR11, TR12, and TR13 are high-withstand-voltage transistors, each of which has a thick gate insulating film.

Each of the transistors TR11, TR12, and TR13 includes diode connection in which a gate is connected to one end of a current path. A power supply voltage VCC is supplied to the gate of the transistor TR11 and the one end of the current path. The other end of the current path of the transistor TR11 is connected to the gate and one end of the current path of the transistor TR12. In addition, the other end of the transistor TR12 is connected to the gate and one end of the current path of the transistor TR13.

A clock signal /CLK is inputted to an input end of the inverter IV3, and a clock signal CLK is inputted to an input end of the inverter IV4. An output end of the inverter IV3 is connected to a part between the current path of the transistor TR11 and the current path of the transistor TR12 through the capacitor C11. An output end of the inverter IV4 is connected to a part between the current path of the transistor TR12 and the current path of the transistor TR13 through the capacitor C12. In addition, the output end of the inverter IV3 is also connected to the other end of the current path of the transistor TR13 through the capacitor C13. The other end of the current path of the transistor TR13 outputs the voltage VPASS.

In the charge pump 12, capacitors and diode-connected MOS transistors, that is, basic unit circuits 21, each of which includes a capacitor and a diode, are connected in series and at multiple stages, and a pulse-like clock signal (bias voltage) /CLK or CLK is inputted to one electrode of each capacitor. Thereby, electric charges which are stored in the capacitor of one basic unit circuit 21 are transferred to the next stage (basic unit circuit 21) for each clock, and the potential of the capacitive load of the output is increased.

### [3] Operation of Boosting Circuit

Next, operation of the boosting circuit in the embodiment will be explained hereinafter.

In the clock signal generating circuit illustrated in FIG. 2, “High (H)” is inputted as enable signal EN in normal operation, and the transistor TR4 is turned on. Then, a monitor voltage MON1 which is obtained by voltage division by the resistors R1, R2 and R3 is inputted to the positive input end of the differential amplifier OP1.

The differential amplifier OP1 compares the monitor voltage MON1 with the reference voltage VREF1, and outputs a signal POUT which is determined according to a comparison result from its output end to the gate of the transistor TR1. Thereby, a voltage PMPDRREF is inputted to the gate of the transistor TR6, and a voltage VCLKSUP which is controlled to a first predetermined voltage according to the voltage PMPDRREF is supplied to the clock driver 11.

On the other hand, when evaluation is performed, the enable signal EN is changed to “Low (L)”, and the test signal TEST is changed to “H”. Thereby, the transistor TR4 is turned off, and the transistor signal TR5 is turned on. Then, a monitor voltage MON1 which is obtained by voltage division by the resistors R1 and R2 is inputted to the positive input end of the differential amplifier OP1.

The differential amplifier OP1 compares the monitor voltage MON1 with the reference voltage VREF1, and outputs a signal POUT which is determined according to a comparison result from its output end to the gate of the transistor TR1. Thereby, a voltage PMPDRREF is inputted to the gate of the transistor TR6, and a voltage VCLKSUP, which is controlled to a second predetermined voltage that is higher than the first predetermined voltage in accordance with the voltage PMPDRREF, is supplied to the clock driver 11.

In evaluation, a potential on the source side of the transistor TR3, that is, a potential which corresponds to the voltage VCLKSUP is set to be higher than the potential in normal operation, and thus the voltage of the signal POUT decreases. Therefore, the voltage PMPDRREF becomes higher than that in normal operation.

For example, supposing that the current which flows through the resistor is I, the reference voltage VREF1 is 1.2 V, the resistance of the resistor R1 is 100Ω, the resistance of the resistor R2 is 80Ω, and the resistance of the resistor R3 is 12.5Ω, the voltage VCLKSUP can be increased as follows by controlling the voltage PMPDRREF by the test signal TEST. In normal operation, the voltage PMPDRREF is set to 2.5 V.

When the test signal TEST is “L” and the enable signal EN is “H” (in normal operation),

$$\begin{matrix}VCLKSUP = I ( R 1 + R 2 + R 3 ) \\ = VREF 1 ( R 1 + R 2 + R 3 ) / ( R 2 + R 3 ) \\ = 2.5\end{matrix}$$

When the test signal TEST is “H” and the enable signal EN is “L” (in evaluation),

$$\begin{matrix}VCLKSUP = I ( R 1 + R 2 ) \\ = VREF 1 ( R 1 + R 2 ) / R 2 \\ = 2.7\end{matrix}$$

According to the above expressions, the voltage CLKSUP in normal operation is 2.5 V, and the voltage CLKSUP in evaluation is 2.7 V. The voltage CLKSUP is supplied to the clock driver 11, and a clock signal PMPCLK (2.5 V or 2.7 V) is outputted from the clock driver 11.

Thereafter, the clock signal PMPCLK which is outputted from the clock driver 11 is inputted to a clock booster (not shown), amplified by the clock booster, and inputted to the voltage generating circuit.

An enable signal ENA is inputted to the voltage generating circuit illustrated in FIG. 3, and thereby the charge pump 12 is activated. The charge pump 12 receives clock signals CLK and /CLK which are outputted from the clock driver 11 and amplified by the clock booster, and the power supply voltage VCC. In the voltage generating circuit, the charge pump 12 boosts the power supply voltage VCC, and outputs the voltage VPASS. When, for example, 2.5 V is outputted as the clock signal PMPCLK, the power supply voltage VCC is boosted by the basic unit circuits 21 of the multiple stages, and thereby a first voltage is generated. In addition, for example, when 2.7 V is outputted as the clock signal PMPCLK, the voltage is boosted to a higher voltage by each basic unit circuit 21 among the basic unit circuits 21, and thereby a second voltage which is higher than the first voltage is generated.

The voltage VPASS is subjected to voltage division by the resistor R4 and the resistor R5, and the divided monitor voltage MON2 is inputted to the negative input end of the differential amplifier OP2. The reference voltage VREF2 is inputted to the positive input end of the differential amplifier OP2. The differential amplifier OP2 compares the monitor voltage MON2 with the reference voltage VREF2, and outputs a signal FLAG which is determined according to a comparison result from its output end to the charge pump 12.

Thereby, when the voltage VPASS is lower than a predetermined voltage, the charge pump 12 is activated by the signal FLAG, and the voltage VPASS is boosted to a voltage which is close to the predetermined voltage. On the other hand, when the voltage VPASS is higher than the predetermined voltage, the charge pump 12 is inactivated by the signal FLAG, boosting of the voltage VPASS is stopped, and thereby the voltage VPASS becomes close to the predetermined voltage. By the above method, the voltage VPASS is maintained at the predetermined voltage.

Next, operation of the charge pump will be explained in detail hereinafter with reference to FIG. 4. In the explanation, the enable signal ENA and the signal FLAG are omitted.

The charge pump 12 receives the power supply voltage VCC, and the clock signals CLK and /CLK which are outputted from the clock driver 11 and boosted by the clock booster. In the charge pump, basic unit circuits 21, each of which includes a capacitor and a diode-connected MOS transistor, are connected in series and at multiple stages (three stages in the explanation).

The pulse-like clock signals CLK and /CLK are inputted to one electrode of the capacitor in each basic unit circuit 21. Thereby, the electric charges which are stored in the capacitor in one basic unit circuit 21 are transferred to the next stage (basic unit circuit 21) for each clock, and thereby the potential of the capacitive load of the output is increased.

The present embodiment includes a control circuit, a switch circuit, the clock driver 11, and the charge pump 12. The control circuit includes the differential amplifier OP1, the transistors TR1 and TR3, and the resistor R1. The control circuit controls the voltage VCLKSUP to the predetermined voltage, based on the monitor voltage MON1 to monitor the voltage VCLKSUP (output voltage). The switch circuit includes the transistors TR4 and TR5, and the resistors R2 and R3. The switch circuit sets the monitor voltage MON1 to the first voltage in normal operation, and set the monitor voltage to the second voltage in evaluation. The clock driver 11 generates a clock signal, by using the voltage level (amplitude) of the voltage VCLKSUP as the voltage level (amplitude) of the clock signal. The charge pump 12 has a structure wherein unit circuits 21, each of which includes a capacitor and a diode, are connected in series and at multiple stages. The charge pump 12 boosts the power supply voltage VCC by the clock signal inputted to the capacitors.

According to the present embodiment, the output of the circuit which generates the power supply of the clock signal in the boosting circuit is temporarily (when evaluation is performed) increased, thereby the voltage can be boosted to a higher voltage by one pumping of one basic unit circuit 21, and thus it is possible to improve the boosting performance.

Thereby, it becomes unnecessary to increase the number of stages of the charge pump (basic unit circuits 21) in the boosting circuit to satisfy the performance which is higher than that provided by the product specification, and thus it is possible to form the boosting circuit with the least number of stages of the charge pump which is required to satisfy the product specification. In addition, the power consumption can be reduced by reducing the number of stages of the charge pump, and thus the boosting efficiency can be improved. Besides, the specification of the boosting circuit which is necessary for evaluation can be eased, and thus it is possible to avoid increase in the circuit area of the peripheral circuit and current consumption.

### [4] Relation Between the Number of Stages of Charge Pump and Boosted Voltage

The following is explanation of relation between the number of stages of the basic unit circuits 21 in the charge pump and the boosted voltage in the boosting circuit of the embodiment. In the explanation, suppose that the power supply voltage VCC which is supplied to the charge pump is 3.3 V. In evaluation, it is unnecessary to secure the lowest voltage 2.7 V which is provided in the product specification, and thus suppose that 3.3 V can be used.

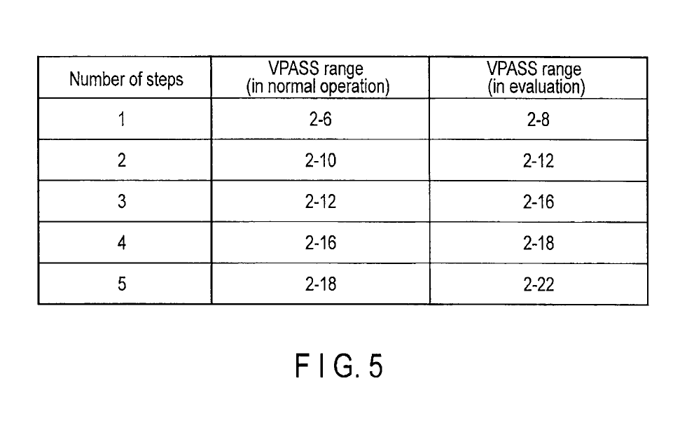

FIG. 5 is a diagram illustrating relation between the number of stages of the charge pump in the boosting circuit and the boosted voltage.

As illustrated in FIG. 5, for example, when the number of stages of the basic unit circuits in the charge pump is 2, the voltage VPASS can be boosted from 2 to 10 V in normal operation. When evaluation is performed in the present embodiment, the amplitude of the clock signal can be set higher than the amplitude in normal operation, and thus the voltage VPASS can be boosted from 2 to 12 V.

In addition, for example, when the number of stages of the basic unit circuits in the charge pump is 3, the voltage VPASS can be boosted from 2 to 12 V in normal operation. When evaluation is performed in the present embodiment, the amplitude of the clock signal can be set higher than the amplitude in normal operation, and thus the voltage VPASS can be boosted from 2 to 16 V.

Besides, for example, when the number of stages of the basic unit circuits in the charge pump is 4, the voltage VPASS can be boosted from 2 to 16 V in normal operation. When evaluation is performed in the present embodiment, the amplitude of the clock signal can be set higher than the amplitude in normal operation, and thus the voltage VPASS can be boosted from 2 to 18V. As described above, when evaluation is performed, the voltage VPASS can be boosted to a voltage which is wider and higher than that in normal operation.

In prior art, there are no structures of increasing the amplitude of the clock signal in evaluation. Therefore, in prior art, when the voltage VPASS which is provided in the product specification can be boosted from 2 to 10 V and it is necessary to boost the voltage VPASS from 2 to 12 V when evaluation is performed, it is required to increase the basic unit circuits to three stages. On the other hand, according to the present embodiment, the voltage VPASS can be boosted from 2 to 12 V by the basic unit circuits of two stages, and thus it is possible to reduce the number of stages of the basic unit circuits by one.

As described above, by reducing the number of stages of the basic unit circuits in the charge pump, it is possible to reduce the current consumption, and improve the boosting efficiency. In addition, it is possible to ease the specification of the boosting circuit which is required when evaluation is performed, and it is possible to avoid increase in the circuit area of the peripheral circuit and increase in the current consumption.

Although there are cases where a cell which is used for evaluation bears an excessive load in “evaluation” explained in each embodiment, proper evaluation can be performed without an excessive load history left on shipped products, by not shipping devices which are evaluated as samples. By using the evaluation technique as described above, it is possible to provide a semiconductor device which includes a boosting circuit with a reduced circuit area and high boosting efficiency (low power consumption), while the temperature characteristics and the transistors characteristic (threshold condition) dependency of the memory cells are properly evaluated.

As explained above, according to the embodiment, it is possible to realize a semiconductor device which includes a boosting circuit with a reduced circuit area and high boosting efficiency.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device comprising:
a control circuit which controls an output voltage to a predetermined voltage, based on a monitor voltage configured to monitor the output voltage;
a switch circuit which sets the output voltage to a first voltage in a first operation state, and sets the output voltage to a second voltage in a second operation state, the second voltage being higher than the first voltage;
a clock driver which generates a clock signal that includes a voltage level of the output voltage as an amplitude thereof; and
a charge pump which is formed by connecting unit circuits, each of which includes a capacitor and a diode, in series and at multiple stages, the charge pump boosting an input voltage by the clock signal that is inputted to the capacitor.

2. The semiconductor device according to claim 1, wherein the control circuit includes:
a differential amplifier which compares the monitor voltage with a reference voltage, and outputs a comparison signal that is based on a comparison result;
a first transistor which includes a gate, to which the comparison signal is inputted, and outputs a third voltage that is determined according to the comparison signal; and
a second transistor which includes a gate, to which the third voltage is inputted, and outputs the output voltage that is determined according to the third voltage.

3. The semiconductor device according to claim 2, wherein the control circuit includes a third transistor which includes a gate, to which the third voltage is inputted, the third transistor outputs a fourth voltage that is determined according to the third voltage, and
the fourth voltage is supplied as the monitor voltage to the differential amplifier through a first resistor.

4. The semiconductor device according to claim 3, wherein the switch circuit includes:
a fourth transistor, to which the fourth voltage that is outputted from the third transistor is inputted through a second resistor; and
a fifth transistor, to which the fourth voltage is inputted through a third resistor.

5. The semiconductor device according to claim 4, wherein the second resistor has a resistance value which is higher than a resistance value of the third resistor.

6. The semiconductor device according to claim 1, wherein each of the unit circuits includes a circuit in which a first electrode of the capacitor is connected to an output end of the diode, and the clock signal is supplied to a second electrode of the capacitor.

7. The semiconductor device according to claim 1, wherein the diode includes a transistor in which a gate is connected to one end of a current path.

8. The semiconductor device according to claim 1, wherein the first operation state includes normal operation, and the second operation state includes evaluation operation.

9. A semiconductor device comprising:
a charge pump which is formed by connecting unit circuits, each of which includes a capacitor and a diode-connected MOS transistor, in series and at multiple stages, the charge pump boosting a voltage by a clock signal that is inputted to the capacitor; and
a generating circuit which generates the clock signal,
wherein the two-stages charge pump can boost the voltage to 10 V, when an amplitude of the clock signal has a voltage of 2.5 V at normal operation, and can boost the voltage to 12 V, when an amplitude of the clock signal has a voltage of 2.7 V at evaluation.

10. The semiconductor device according to claim 9, wherein the generating circuit includes:
a control circuit which controls an output voltage to a predetermined voltage, based on a monitor voltage configured to monitor the output voltage;
a switch circuit which sets the output voltage to a first voltage in a first operation state, and sets the output voltage to a second voltage in a second operation state, the second voltage being higher than the first voltage; and
a clock driver which generates the clock signal that includes a voltage level of the output voltage as an amplitude thereof.

11. The semiconductor device according to claim 10, wherein the control circuit includes:
a differential amplifier which compares the monitor voltage with a reference voltage, and outputs a comparison signal that is based on a comparison result;
a first transistor which includes a gate, to which the comparison signal is inputted, and outputs a third voltage that is determined according to the comparison signal; and
a second transistor which includes a gate, to which the third voltage is inputted, and outputs the output voltage that is determined according to the third voltage.

12. The semiconductor device according to claim 11, wherein the control circuit includes a third transistor which includes a gate, to which the third voltage is inputted, the third transistor outputs a fourth voltage that is determined according to the third voltage, and
the fourth voltage is supplied as the monitor voltage to the differential amplifier through a first resistor.

13. The semiconductor device according to claim 12, wherein the switch circuit includes:
a fourth transistor, to which the fourth voltage that is outputted from the third transistor is inputted through a second resistor; and
a fifth transistor, to which the fourth voltage is inputted through a third resistor.

14. The semiconductor device according to claim 13, wherein the second resistor has a resistance value which is higher than a resistance value of the third resistor.

15. The semiconductor device according to claim 9, wherein each of the unit circuits includes a circuit in which a first electrode of the capacitor is connected to an output end of the diode, and the clock signal is supplied to a second electrode of the capacitor.

16. The semiconductor device according to claim 9, wherein the diode includes a transistor in which a gate is connected to one end of a current path.

17. The semiconductor device according to claim 9, wherein the first operation state includes normal operation, and the second operation state includes evaluation operation.
